(19) United States
(12) Patent Application Publication
(10) Pub. No.: US 2026/0238503 A1
(43) Pub. Date: Aug. 13, 2026

(54) FRAUD-RESISTANT BLOCKCHAIN VALIDATIONS

(71) Applicant: Reynold Vogel Inc., Portland, OR (US)

(72) Inventor: Matthew Vogel, Portland, OR (US)

(73) Assignee: Reynold Vogel Inc., Portland, OR (US)

(21) Appl. No.: 19/529,612

(22) Filed: Feb. 4, 2026

Related U.S. Application Data
(60) Provisional application No. 63/753,814, filed on Feb. 4, 2025.

(51) Int. Cl. H04L 9/00; H04L 9/08; H04L 9/32

(52) U.S. Cl. CPC H04L 9/50; H04L 9/0861; H04L 9/3242; H04L 9/3247

(57) ABSTRACT

Systems and methods for enhancing blockchain security using a multi-rotation key derivation mechanism and on-chain validation are disclosed. The system prevents unauthorized transactions by cryptographically enforcing key rotations and maintaining an immutable key event log on-chain. Each transaction includes pre-rotated and twice-pre-rotated key hashes, which validator nodes retrieve and compare against stored on-chain records to ensure cryptographic continuity. The disclosed systems and methods eliminate reliance on static key validation and proactively prevent key compromise attacks by requiring a continuous and verifiable sequence of key rotations.

### CROSS-REFERENCE TO RELATED APPLICATIONS

This application claims the benefit of U.S. Provisional Patent Application No. 63/753,814, which was filed on Feb. 4, 2025 and entitled “Fraud-Resistant Blockchain Validations.” The complete disclosure of the above application is hereby incorporated by reference for all purposes.

### FIELD OF THE DISCLOSURE

The present disclosure relates to cryptographic systems and methods. More particularly, it pertains to technologies for ensuring the integrity, security, and validation of data in systems, including blockchain networks and decentralized systems.

### BACKGROUND

Blockchains are tamper-evident and tamper-resistant digital ledgers implemented in a distributed manner, typically without a central repository or authority. At their core, they enable a network of participants to record transactions in a shared ledger, ensuring that no transaction can be altered once published under normal operational conditions. The concept combines technologies, such as cryptographic functions and distributed systems, into a cohesive framework, offering a secure and transparent way to manage data and transactions across various applications. Beyond digital currencies, blockchain technology may be used in fields, such as secure data storage, supply chain management, smart contracts, and more.

Blockchain networks are generally categorized as permissionless or permissioned. Permissionless networks allow open participation in reading and writing data but require robust mechanisms to address unauthorized actors. In contrast, permissioned networks restrict access to authorized participants, enabling finer control over governance and operations. Despite the advantages offered by these systems, several operational, technical, and governance challenges persist, including managing security vulnerabilities and handling unauthorized users and transactions.

Blockchain technology relies on cryptographic keys for transaction signing and validation. Private keys are used to digitally sign transactions and authorize the transfer of rights, while public keys allow others to verify the validity of these transactions. This cryptographic mechanism, combined with distributed management, attempts to ensure resilience against unauthorized modifications and provides transparency. However, private key management remains a significant vulnerability, enabling unauthorized users to generate valid, impersonated signatures for unauthorized transactions. This leads to asset loss and compromises the integrity of the network.

Multi-signature wallets and threshold cryptography attempt to mitigate the risks of private key compromise. However, they often introduce additional complexity and operational burdens. These methods are typically reactive, focusing on limiting damage after a breach rather than preventing unauthorized transactions. Moreover, current consensus mechanisms, such as Proof of Work (PoW) and Proof of Stake (PoS), validate transactions based on the correctness of cryptographic signatures but do not account for the misuse of compromised keys. This creates a critical gap in blockchain security, as fraudulent transactions may still be included in the ledger before the breach is identified.

What is needed, therefore, are methods and systems for enhanced blockchain security by proactively preventing unauthorized access and fraudulent activity through multi-rotation key derivation mechanisms combined with on-chain validations. The methods and systems address the vulnerabilities of traditional key management systems while seamlessly integrating with existing blockchain infrastructures, offering improved security without significant operational or computational overhead.

### BRIEF DESCRIPTION OF THE DRAWINGS

For a better understanding of the disclosure, and to show how the same may be carried into effect, reference will now be made, by way of example, to the accompanying drawings, in which:

FIGS. 1-2 illustrate a high-level architecture of a blockchain network, showing interconnected nodes and a distributed ledger.

FIGS. 3-4 depict a high-level system architecture for implementing a multi-rotation key derivation mechanism and on-chain validation.

FIG. 5 is a flowchart of a multi-rotation key derivation process.

FIG. 6 is a flowchart illustrating the transaction validation process.

### DETAILED DESCRIPTION

Various embodiments of methods and systems for enhancing blockchain security through a multi-rotation key derivation mechanism combined with on-chain validation are configured to transmit data between two devices are described below and illustrated in the associated drawings. Unless otherwise specified, the methods and systems for enhancing blockchain security through a multi-rotation key derivation mechanism combined with on-chain validation and/or their various components may contain at least one of the structures, components, functionalities, and/or variations described, illustrated, and/or incorporated herein. Furthermore, the structures, components, functionalities, and/or variations described, illustrated, and/or incorporated herein in connection with the present disclosure may be included in other similar data transmission systems. The following description of various embodiments is merely illustrative in nature and is in no way intended to limit the disclosure, its application, or uses. Additionally, the advantages provided by the embodiments, as described below, are illustrative in nature and not all embodiments provide the same advantages or the same degree of advantages.

In addition, the methods and systems may leverage quantum computing technologies for complex cryptographic analysis, providing enhanced security and scalability. Furthermore, edge computing could be incorporated to perform localized real-time analysis, reducing latency and improving the responsiveness of the security assessments. Integration with decentralized identity systems (such as DID) and self-sovereign identity frameworks may also ensure secure, user-controlled data management.

Aspects of methods and systems for enhancing blockchain security through a multi-rotation key derivation mechanism combined with on-chain validation may be embodied as a computer method, computer system, or computer program product. Accordingly, aspects of the methods and systems for enhancing blockchain security through a multi-rotation key derivation mechanism combined with on-chain validation may take the form of an entirely hardware embodiment, an entirely software embodiment (including firmware, resident software, micro-code, and the like), or an embodiment combining software and hardware aspects, all of which may generally be referred to herein as a “circuit,” “module,” and/or “system.” Furthermore, aspects of the methods and systems for enhancing blockchain security through a multi-rotation key derivation mechanism combined with on-chain validation may take the form of a computer program product embodied in a computer-readable medium (or media) having computer-readable program code/instructions embodied thereon.

Additionally, embodiments may include the use of secure multiparty computation (SMPC) for distributed processing of sensitive data without exposing it to any single party. The methods and systems could also leverage federated learning to train Artificial Intelligence (AI) models across decentralized data sources, preserving privacy while improving the security of recovery methods. Blockchain technology may be employed as the basis for methods and systems for enhancing blockchain security through a multi-rotation key derivation mechanism combined with on-chain validation.

Any combination of computer-readable media may be utilized. Computer-readable media can be a computer-readable signal medium and/or a computer-readable storage medium. A computer-readable storage medium may include an electronic, magnetic, optical, electromagnetic, infra-red (IR), and/or semiconductor system, apparatus, or device, or any suitable combination of these. More specific examples of a computer-readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, a solid-state drive, a non-volatile memory express (NVMe) drive, and/or any suitable combination of these and/or the like. Quantum storage mediums may also be leveraged in future embodiments to further enhance the capacity and speed of storage systems. In the context of this disclosure, a computer-readable storage medium may include any suitable tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including electro-magnetic, optical, audible, and/or any suitable combination thereof. A computer-readable signal medium may include any computer-readable medium that is not a computer-readable storage medium and that is capable of communicating, propagating, or transporting a program for use by or in connection with an instruction execution system, apparatus, or device.

Signal mediums may utilize 5G, 6G, or other advanced wireless communication technologies to enable faster and more secure transmission of data. Quantum communication channels, leveraging quantum entanglement, may also be used for secure, high-speed data transmission in future embodiments. Terahertz wave communications may be utilized as part of next-generation wireless data propagation technologies, allowing greater data bandwidth and transmission speeds.

Program code embodied on a computer-readable medium may be transmitted using any appropriate medium, including wireless, wireline, optical fiber cable, radio frequency (RF), and/or the like, and/or any suitable combination of these. Program code may be transmitted using advanced communication methods such as millimeter-wave technology, enabling high-speed data transfer over short distances, or via satellite communication for global coverage in remote or inaccessible areas. The methods and systems may implement quantum key distribution (QKD) to secure data transmissions, ensuring program code integrity and confidentiality during transmission.

Computer program code for carrying out operations for aspects of the systems and methods for evaluating and strengthening security of authentication systems may be written in one or any combination of programming languages, including an object-oriented programming language such as Python, Java, Smalltalk, C++, C Sharp, Swift, Rust, Kotlin, and/or the like, and conventional procedural programming languages, such as the C programming languages. The program code may execute entirely on a user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), and/or the connection may be made to an external computer (for example, through the Internet using an Internet Service Provider).

The systems and methods may also employ serverless architectures, such as Function as a Service (FaaS) platforms such as AWS Lambda, to execute program code dynamically in a distributed cloud environment, optimizing resource usage. Execution across edge computing networks reduces latency by processing data closer to the source, while integration with blockchain-based decentralized networks enables secure, transparent operations across a distributed system.

Aspects of the methods and systems for enhancing blockchain security through a multi-rotation key derivation mechanism combined with on-chain validation are described below with reference to flowchart illustrations and/or block diagrams of methods, apparatuses, systems, and/or computer program products. Each block and/or combination of blocks in a flowchart and/or block diagram may be implemented by computer program instructions. The computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The processor(s) may include central processing units (CPUs), graphics processing units (GPUs), tensor processing units (TPUs), or specialized hardware accelerators designed for cryptographic operations. These processor(s) execute program instructions to perform operations such as key derivation, hash generation, and validation of cryptographic signatures. The methods and systems may utilize neuromorphic processor(s) for efficient and adaptive processing of security-related tasks. Quantum processor(s) may also be integrated for executing complex cryptographic operations at exponentially faster speeds. Moreover, the methods and systems may benefit from the deployment of AI accelerators or TPUs.

The computer program instructions can also be stored in a computer-readable medium that can direct a computer, other programmable data processing apparatus, and/or other device to function in a particular manner, such that the instructions stored in the computer-readable medium produce an article of manufacture including instructions which implement the function/act specified in the flowchart and/or block diagram block or blocks.

The computer program instructions also can be loaded onto a computer, other programmable data processing apparatus, and/or other device to cause a series of operational steps to be performed on the device to produce a computer-implemented process such that the instructions which execute on the computer or other programmable apparatus provide processes for implementing the functions/acts specified in the flowchart and/or block diagram block or blocks. In embodiments, these instructions may be executed in a distributed computing environment using edge computing, where processing occurs closer to the data source, reducing latency. Execution of these instructions may be optimized using AI accelerators, such as TPUs, enhancing the speed and efficiency of AI-driven processes. Quantum computing architectures may also be employed for handling complex computations faster than traditional systems, further enhancing the system's capabilities.

Any flowchart and/or block diagram in the drawings is intended to illustrate the architecture, functionality, and/or operation of possible implementations of systems, methods, and computer program products according to aspects of the methods and systems for enhancing blockchain security through a multi-rotation key derivation mechanism combined with on-chain validation. In this regard, each block may represent a module, segment, or portion of code, which comprises one or more executable instructions for implementing the specified logical function(s). In some implementations, the functions noted in the block may occur out of the order noted in the drawings. For example, two blocks shown in succession may, in fact, be executed substantially concurrently, or the blocks may sometimes be executed in the reverse order, depending upon the functionality involved. Each block and/or combination of blocks may be implemented by special purpose hardware-based systems (or combinations of special purpose hardware and computer instructions) that perform the specified functions or acts. The blocks may be executed in parallel across distributed cloud infrastructures, leveraging serverless architectures to dynamically allocate computational resources based on real-time demand. Quantum processors may also be utilized to perform concurrent executions of logical functions, optimizing the system's computational throughput for high-complexity tasks.

The technical solution provided by the disclosed methods and systems addresses critical vulnerabilities in traditional blockchain security systems and methods by utilizing multi-rotation key derivation mechanisms combined with an on-chain key event log and validation to enhance transaction integrity. Specifically, the system enforces cryptographic continuity by generating pre-rotated and twice-pre-rotated key hashes, which are stored on-chain and validated during consensus. This approach ensures that only cryptographically valid transactions can be executed, even in cases where a private key is compromised.

The disclosed methods and systems, in embodiments, eliminate reliance on static key validation by utilizing dynamic key rotations tied to the blockchain ledger to prevent unauthorized transactions at their root. In embodiments, the methods and systems rely on intrinsic cryptographic validation at the consensus level, ensuring that security is enforced through cryptographic guarantees rather than relying solely on predefined rules. This approach eliminates potential vulnerabilities associated with rule-based validation by embedding security directly into the cryptographic architecture of the blockchain.

In embodiments, the methods and systems process cryptographic operations by performing sequential key rotations to derive next-use keys and their corresponding hashes. The first rotation determines the next private key, while the second and third rotations generate pre-rotated and twice-pre-rotated key hashes, respectively, which are recorded on-chain. During transaction validation, blockchain nodes independently retrieve the corresponding key event log entries and apply cryptographic checks to ensure the submitted transaction adheres to the expected sequence of key rotations. This process establishes a cryptographically linked chain of keys, ensuring transaction integrity and preventing fraudulent activity.

Blockchain technology is a decentralized, distributed ledger system that enables the secure recording and verification of transactions without the need for a central authority. The methods and systems described in this disclosure, in embodiments, operate within and enhance the functionality of blockchain networks, which typically consist of nodes that communicate to maintain a consistent and tamper-resistant ledger of transactions.

A blockchain is composed of blocks, where each block contains two primary components: a block header and block data. The block header includes metadata such as a cryptographic hash of the previous block, a timestamp, and other data necessary for consensus and validation. The cryptographic linkage between blocks creates an immutable chain, ensuring that any attempt to alter the contents of a block would require re-calculation of the cryptographic hashes for all subsequent blocks—a computationally infeasible task under normal circumstances. The block data contains a set of transactions, with each transaction including details such as inputs, outputs, and cryptographic signatures verifying the validity of the transaction.

Blockchain networks are typically categorized into permissionless and permissioned networks. In permissionless networks, any participant can join the network, validate transactions, and contribute to consensus. These networks, often associated with public blockchain platforms, rely on consensus mechanisms such as Proof of Work (PoW) or Proof of Stake (PoS) to maintain integrity and prevent malicious actors from manipulating the ledger. In contrast, permissioned networks restrict participation to authorized entities, enabling finer-grained control over governance and operations while often adopting alternative consensus mechanisms optimized for efficiency and scalability.

The operation of a blockchain network relies on cryptographic techniques for transaction validation and consensus. Transactions are digitally signed using a participant's private key, with the corresponding public key enabling other participants to verify the transaction's authenticity. The validated transaction is then broadcast to the network, where it is aggregated with other transactions into a block. Once a block is constructed, it undergoes consensus validation, during which nodes verify its contents and add it to their local copy of the blockchain if valid. The decentralized nature of blockchain networks ensures that no single entity has control over the ledger, enhancing security and transparency.

Embodiments of the disclosed methods and systems operate within this framework to address critical vulnerabilities associated with blockchain security. Specifically, the methods and systems introduce multi-rotation key derivation mechanisms and on-chain key event logs and validation rules that integrate with existing blockchain structures and consensus mechanisms. This ensures that transaction integrity is maintained even in scenarios where traditional private key management systems are compromised.

The several embodiments of the methods and systems disclosed herein describe various data points and structures, including user-provided data, private keys, public keys, key event log data, transaction data, blockchain data, and more. In embodiments, user-provided inputs, such as the Key Derivation Parameter (KDP), are a part of the key derivation process. This data, which could include a PIN, password, or similar input, ensures that derived keys are unique and tied to the user's credentials. Incorporating the KDP into the system enhances brute force resistance making brute force attacks computationally infeasible without the correct KDP. A formula for key derivation, in embodiments, is as follows:

$${K}_{c h i l d} = HMAC ( {K}_{parent} , KDP )$$

Where:
K_{child}, Child key derived from the parent key.
Kₚₐᵣₑₙₜ, Parent private key or chaincode.
KDP, Key Derivation Parameter (e.g., PIN/password).
HMAC, Hash-based Message Authentication Code using SHA-256.

For brute force resistance, the following search space formula is utilized in embodiments:

$$S = {N}^{R}$$

Where:
S, Total search space.
N, Maximum number of child keys derivable from a parent key.
R, Number of rotations (e.g., 4 in this case).

In embodiments, private keys serve as the cryptographic foundation for signing transactions. Each transaction is signed with the user's private key, linking it securely to their identity. During the multi-rotation process, the private key undergoes transformations to generate pre-rotated and twice-pre-rotated key hashes for future validation. The private key itself remains unexposed, maintaining its security throughout the process. Hashing and address derivation, in embodiments, follows the following formula:

$${A}_{p u b} = RIPEMD 160 ( SHA 256 ( {P}_{p u b} ) )$$

Where:
P_{pub}, public key.
A_{pub}, blockchain-compatible address.

The public key is hashed twice to generate the transaction address, ensuring compactness and privacy. The resulting address is matched against the on-chain key log during validation.

Public keys, derived from private keys, are used for validation within the system. Validator nodes hash public keys to generate addresses, which are then compared against pre-rotated key hashes stored in the on-chain key event log. This ensures that the public key aligns with the expected key rotation sequence and serves as a unique identifier for transactions.

The key event log, stored on-chain, contains records of pre-rotated and twice-pre-rotated key hashes. This data ensures continuity and validation of the key rotation sequence, providing a cryptographic trail for validating transactions. By enforcing adherence to the rotation sequence, the key event log prevents unauthorized transactions and establishes a tamper-resistant system for maintaining blockchain integrity.

Transaction data includes fields, such as the public key, outputs (e.g., UTXOs), and other standard transaction details. Each transaction is hashed using SHA-256 and signed with the private key, generating a verifiable digital signature. Validator nodes cross-reference outputs against pre-rotated key hashes in the key event log to ensure alignment with the on-chain sequence. For transactions requiring additional conditions, the system can validate relationships and require confirming transactions where applicable.

Blockchain data serves as the immutable distributed ledger that records transactions and the on-chain key event logs. By maintaining redundancy and ensuring data integrity through consensus mechanisms, the blockchain provides a secure foundation for all operations. The decentralized nature of the blockchain ensures that all records, including key rotations, key event logs and transaction data, remain tamper-proof and verifiable across the network.

Various data transformations are employed in embodiments of the method and systems to ensure cryptographic security, validate transactions, and maintain the integrity of the blockchain. In embodiments, the Key Derivation Parameter (KDP) is combined with the private key and chaincode to derive unique child keys. These transformations cryptographically link the derived child keys to the user's credentials, enhancing brute force resistance and ensuring security. The output is a unique child key, tied directly to the KDP, that serves as a component of the system's key management.

The private key is utilized for signing transactions and deriving future keys. During the multi-rotation process, the private key undergoes three transformations: (1) generating the next private key (first rotation), (2) producing the pre-rotated key hash (second rotation), and (3) creating the twice-pre-rotated key hash (third rotation). These transformations rely on cryptographic hash functions, such as SHA-256, to ensure security. The resulting pre-rotated and twice-pre-rotated key hashes are logged on-chain and serve as the basis for transaction validation and key continuity. In embodiments, the second and third rotations are provided on the public key hashes and are immediately deleted.

The public key, derived from the private key using, for example, elliptic curve cryptography (e.g., ECDSA), undergoes further transformation to produce a blockchain-compatible address. Specifically, the public key is hashed using algorithms such as SHA-256 and RIPEMD-160, resulting in a unique address used for validation. This output serves as the identifier for transactions within the blockchain and ensures alignment with the on-chain key event log during validation.

In embodiment, the transformation of a public key into a public key hash conceals the actual public key until it is revealed in a transaction, enhancing security by preventing potential preemptive attacks. The forward knowledge provided by the hash allows the key holder to preemptively inform the blockchain network which set of public keys and their corresponding hashes should be used for verification. This approach strengthens cryptographic continuity while maintaining a structured validation framework that is resistant to unauthorized modifications.

Raw transaction data includes components, such as the public key, outputs (UTXOs), and other relevant fields. This data is hashed, for example using SHA-256, to create a unique transaction identifier, which is then signed with the private key to generate a digital signature. The output is a signed transaction with an associated hash and public key, ready for validation against the system's cryptographic rules.

The key event log stores pre-rotated and twice-pre-rotated key hashes derived during the multi-rotation process. These hashes are logged on-chain, providing a cryptographic trail for validating transactions. During the validation process, the logged hashes are compared with the hashed public key of the transaction. If the hashes align with the expected rotation sequence, the transaction is validated; otherwise, it is rejected.

Validation rules ensure that all transactions conform to the system's cryptographic sequence. Input data, such as the public key, outputs, and relationship fields, are checked against the on-chain key event log. The rules verify whether the transaction's public key matches the logged pre-rotated key hash and whether any conditional requirements (e.g., specific outputs or metadata in the relationship field) trigger additional confirmation steps. Based on compliance with these rules, the transaction is either accepted or rejected, ensuring unauthorized actions are flagged and blocked.

Blockchain transaction data, in embodiments, include recipient address(es), transfer amount(s), and optional metadata fields (e.g., relationship fields). These details are processed alongside cryptographic data to ensure the transaction adheres to the system's validation requirements and is properly recorded on the blockchain.

Moreover, the methods and systems provide a range of outputs to ensure users and developers have clear feedback on transaction statuses, key rotation management, validation results, and blockchain records. Transaction statuses may be provided by the system for real-time feedback. Statuses may include “pending,” “validated,” or “rejected.” “Pending” indicates the transaction is in the mempool awaiting validation. “Validated” confirms the transaction has passed validation and has been added to a block. “Rejected” denotes the transaction failed validation due to rule violations. Display options include user interface (UI) and application programming interface (API) responses. For example, UI for wallets or blockchain explorers may show status messages or color-coded indicators, such as “Transaction #12345: Validated and Included in Block #67890.” For API response, outputs in JSON or XML format enable integration with other applications, e.g., {“transaction_id”: “12345”, “status”: “validated”, “block”: “67890”}. Users, in embodiments, can adjust transaction inputs (e.g., recipient address, metadata) based on rejection feedback.

Key rotation data, including pre-rotated and twice-pre-rotated key hashes, is automatically logged on-chain. While the process is automated, users may indirectly influence key rotations by initiating new transactions in embodiments. Display options include developer dashboards, blockchain explorers, and more. For developer dashboards, graphical displays may be utilized to show the sequence of key rotations for monitoring purposes. For blockchain explorers, transaction metadata may include key rotation details, such as: Current Key Hash: ‘abc123 . . . ’; Pre-Rotated Key Hash: ‘def456 . . . ’; and Twice-Pre-Rotated Key Hash: ‘ghi789 . . . . ’

Validation outputs, in embodiments, provide insight into why a transaction was accepted or rejected, including details of validation checks performed. Checks, in embodiments, include matching a transaction's public key with pre-rotated hashes and compliance with outputs and relationship field rules. Display options include messages (e.g., error messages), detailed logs, and more. For example, a message may be shown to a user detailing why a transaction failed, e.g., “Transaction Rejected: Output address does not match pre-rotated key hash.” Detailed logs, in embodiments, are available to node operators and developers, providing granular insights into validation checks. For example, logs may indicate the following—Public Key Match: Passed; Outputs Field Match: Failed; Relationship Field Compliance: Passed.

In embodiments, immutable records of transactions and key event log entries are maintained on-chain. Display options include inclusion in public ledgers, custom reports, and more. For public ledger inclusion, blockchain explorers display raw or parsed data, such as: Transaction ID: 12345; Outputs (Address: xyz890 . . . ; Amount: 10.5 Digital Currency); Key Event Log (Twice-Pre-Rotated Hash: ghi789 . . . ; Pre-Rotated Hash: def456 . . . ). For custom reports, applications generate reports for auditing or compliance purposes, summarizing transaction and key rotation data.

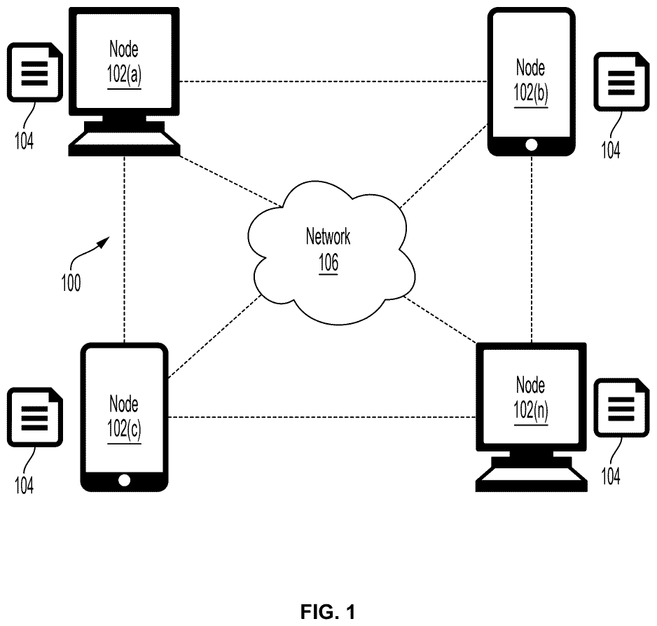

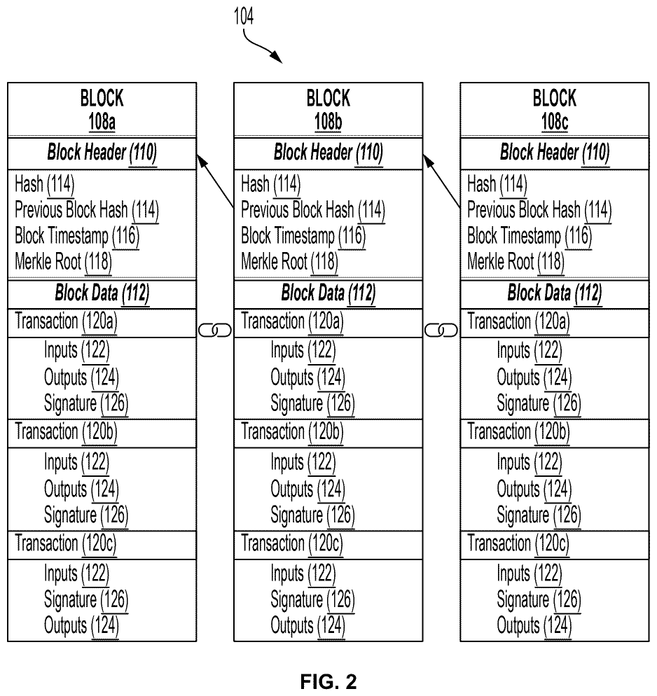

FIGS. 1-2 illustrate a high-level architecture of a blockchain network (100). The blockchain network (100) includes a plurality of interconnected nodes (102a, 102b, 102c, 102n), each representing a computing device capable of performing cryptographic operations, validating transactions, and maintaining a local copy of the blockchain ledger (104). The nodes (102) are interconnected via a network (106), such as the internet or a private communication network, enabling distributed data sharing and processing.

Each node (102) includes a processor, memory, and a network interface. The processor is configured to execute instructions for verifying transactions, creating new blocks and transactions, and validating consensus mechanisms. The memory stores the node's local copy of the blockchain ledger (104) and other necessary data, such as cryptographic keys and transaction metadata. The network interface allows each node to communicate with other nodes in the blockchain network (100) to propagate transactions and blocks.

The blockchain ledger (104) consists of a sequential chain of blocks (108a, 108b, 108c . . . 108n), where each block (108) is cryptographically linked to the previous block to form an immutable structure. Each block (108) includes a block header (110) and block data (112). The block header (110) may contain metadata such as: a previous block hash (114), which links the block (108) to the prior block in the chain, a block timestamp (116), representing the time at which the block was created, and a Merkle root (118), summarizing the cryptographic hashes of all transactions contained within the block.

The block data (112) includes a list of transactions or key events (120a, 120b, 120c), with each transaction including: Inputs (122) that reference outputs of prior transactions, outputs (124) representing the transfer of digital assets or information, and a digital signature (126) that verifies the transaction was authorized by the private key of the sender.

As depicted in FIGS. 1-2, the blockchain network operates in a decentralized manner, with nodes (102a, 102b, 102c) exchanging proposed transactions over the network (106). For example, Node 102c may aggregate validated transactions into a candidate block (e.g., 114d) and broadcasting the new block to the other nodes. Once the block is validated by other nodes (102a, 102b), it is appended to the blockchain ledger (104).

Block chains networks may be permissionless as shown in FIG. 1 or permissioned. In the permissionless blockchain networks, any participant (nodes), can join the network without prior authorization. These nodes are distributed across a public network such as the internet and are interconnected via bidirectional communication links, enabling the propagation of transactions and blocks. Each node in the permissionless network maintains a local copy of the blockchain ledger, which consists of a chain of cryptographically linked blocks.

Permissionless networks employ decentralized consensus mechanisms, such as Proof of Work (PoW) or Proof of Stake (PoS), to validate and append blocks to the blockchain ledger. Transactions are verified independently by multiple nodes to ensure the integrity of the ledger and prevent fraudulent activity. The public nature of the network allows any participant to validate transactions, mine new blocks, or propose updates.

In contrast, permissioned blockchain networks restrict participation to authorized entities. The network consists of a limited number of authenticated nodes, each associated with specific credentials. These nodes are connected via a private network, providing controlled communication links for secure transaction processing and block validation. The blockchain ledger in the permissioned network is maintained with stricter governance policies, such as a governing entity. This governing entity oversees the operations of the network, including permission management, policy enforcement, and conflict resolution.

Transactions in the permissioned blockchain network are processed by authorized nodes, with each transaction being logged in the blockchain ledger. The governing entity may use an administrative interface to manage user permissions, monitor network activity, and configure system settings. For example, the governing entity can grant or revoke access to nodes. The permissioned network uses a consensus mechanism optimized for efficiency, such as Practical Byzantine Fault Tolerance (PBFT) or Raft, to validate and append blocks.

There are several differences between the two types of blockchain networks. The permissionless network allows unrestricted participation, while the permissioned network limits access to authorized entities. The permissionless network relies on decentralized consensus mechanisms, whereas the permissioned network is centrally governed by an administrative entity. The permissionless network may face scalability challenges due to its decentralized nature, while the permissioned network benefits from controlled participation and optimized consensus mechanisms. The permissionless network offers full transparency of transactions to all participants, while the permissioned network restricts visibility based on user permissions.

The process of adding a block (e.g., a transaction) to the blockchain may be done through a consensus mechanism. The process begins with the receipt of transactions submitted by users to the blockchain network. These transactions are validated by participating nodes to ensure their authenticity and compliance with the blockchain's rules. Each transaction may contain components including inputs, outputs, and a digital signature. The digital signature, in embodiments, is generated by the sender using their private key, serving as cryptographic proof of the sender's identity.

Once a transaction is verified, it is propagated across the network to other participating nodes. The verified transactions are then collected and organized into a candidate block by a proposer node. The candidate block includes a block header and block data, which contains verified transactions. The block header may include the hash of the previous block linking the new block to the existing blockchain, a timestamp indicating when the block was created, and a block hash, representing the cryptographic summary of the block's contents.

The proposer node organizes the candidate block, which is composed of two main components: the block header and block data. The block data contains a collection of verified transactions. The block header includes information such as the hash of the previous block, which cryptographically links the new block to the existing blockchain, a timestamp indicating when the block was created, and the block hash, a cryptographic summary of the block's contents. The candidate block is then broadcast to validator nodes for validation.

Validator nodes independently validate the candidate block by verifying the integrity of its transactions and ensuring compliance with the blockchain's consensus protocol. The validation process, in embodiments, includes checking the digital signatures of each transaction, confirming that inputs correspond to unspent outputs, and verifying the block header for consistency with consensus rules. For example, the hash of the previous block must accurately link to the most recent block in the chain, the timestamp must fall within an acceptable range, and/or the block hash must meet the consensus protocol's cryptographic requirements, such as a target threshold in Proof of Work (PoW) systems.

Candidate blocks that fail validation are rejected to preserve the integrity of the blockchain. These rejected blocks are depicted separately, along with annotations indicating common reasons for rejection, such as invalid transactions, mismatched hashes, or failure to meet consensus requirements. The system ensures that only valid transactions and blocks are incorporated into the blockchain, maintaining a secure and tamper-resistant ledger.

Significant challenges remain in ensuring the integrity, continuity, and security of cryptographic keys used in traditional systems. In these systems, users rely on private keys to sign transactions, and these keys serve as the sole proof of authorization. If a private key is compromised—due to hacking, phishing, or user error—an attacker can generate valid signatures and initiate fraudulent transactions, leading to asset loss and diminished trust in the network. Current mitigation strategies, such as multi-signature wallets or threshold cryptography, aim to reduce the impact of compromised keys but often introduce additional complexity and overhead for users, making them less practical for widespread adoption.

Another risk arises from the static nature of key management in traditional systems. Once a private key is compromised, there are no cryptographic mechanisms in place to invalidate or replace the key within the blockchain network effectively. This static approach creates a critical vulnerability, as attackers can exploit the compromised key until the network implements external countermeasures, such as manually blacklisting the key or reissuing new ones—actions that are slow, labor-intensive, and prone to errors.

Existing validation mechanisms also lack proactive methods to ensure the forward security of transactions. Some traditional blockchain systems primarily rely on the verification of digital signatures and cryptographic hashes but do not address the issue of ensuring that keys used in one transaction cannot be reused maliciously in subsequent transactions. This absence of cryptographic linkage between transactions leaves systems vulnerable to attacks where stolen keys are used to fabricate unauthorized transactions.

The methods and systems disclosed herein address these challenges by enhancing blockchain security through the introduction of multi-rotation key derivation mechanisms combined with on-chain key event log validations to proactively prevent unauthorized access and fraudulent transactions. This ensures prevention at the consensus level by cryptographically validating transactions against an on-chain logged sequence of key rotations, rejecting invalid or fraudulent transactions outright during consensus rather than merely monitoring or flagging them. The result of the combination multi-rotation key derivation and on-chain validation prevents attackers from using stolen private keys to sign valid transactions. As an added layer of protection several embodiments incorporate a Key Derivation Parameter (KDP) in the derivation mechanisms. This significantly enhances brute force resistance, rendering such attacks computationally impractical. The several methods and systems integrate seamlessly into existing blockchain networks without requiring significant modifications to the underlying architecture, requiring no coordination between multiple entities, or additional hardware.

The methods and systems utilize a multi-rotation cryptographic key derivation mechanism to generate and manage chains of cryptographic keys. When a private key is used to sign a transaction, it undergoes three rotations. The first rotation specifies the next private key to be used, preventing key reuse and ensuring forward security. The second rotation generates and records a hashed address of the private key two steps ahead in the sequence (pre-rotated key hash), creating a verifiable link for future transactions. The third rotation generates and records a hashed address of the private key three steps ahead (twice pre-rotated key hash), further extending cryptographic continuity. These rotations are securely logged on-chain as part of a key event log or event, creating a tamper-proof record.

Each transaction contains, in embodiments, a single key event log, which includes the twice pre-rotated key hash, pre-rotated key hash, and the public key. Key hashes are generated by applying one-way cryptographic functions (e.g., SHA-256) to the derived public key. During transaction validation, submitted key hashes are compared to the on-chain key event log to verify continuity and prevent tampering.

The methods and systems integrate into a blockchain's transaction validation pipeline, specifically within the key validation and consensus layers. Leveraging the blockchain's existing infrastructure for block storage, consensus enforcement, and distributed redundancy, the system ensures efficient and scalable deployment. By validating transactions against the on-chain key event log, the system adds an additional layer of security, ensuring that only authorized transactions are processed. This integration enhances the blockchain's integrity while maintaining compatibility with its native architecture.

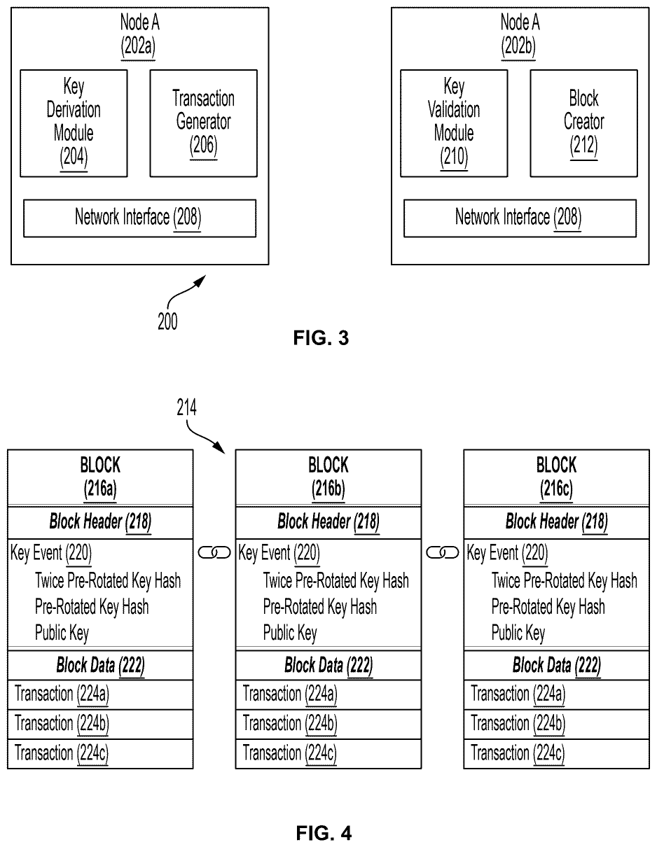

FIGS. 3-4 illustrate a high-level system architecture (200) for implementing the disclosed multi-rotation key derivation mechanism and on-chain validation within a blockchain network. The system includes Node A (202a), Node B (202b), and the distributed Blockchain Ledger (214). Node A (202a) represents a participant in the blockchain network responsible for initiating transactions. It may include a Key Derivation Module (204), which performs the multi-rotation key derivation process to generate the Next-Use Key, Pre-Rotated Key Hash, and Twice-Pre-Rotated Key Hash. These cryptographic outputs ensure transaction integrity and forward security. Node A also includes a Transaction Generator (206) that creates new transactions by embedding the derived cryptographic key hashes, inputs, outputs, and the sender's digital signature into the transaction payload. A Network Interface (208) enables Node A to broadcast the generated transaction to other nodes within the blockchain network.

Node B (202b) serves as a validator node responsible for verifying transactions and creating new blocks. It features a Key Validation Module (210) that retrieves the on-chain key event log from the Blockchain Ledger (214) and validates the submitted cryptographic key hashes and digital signature against the expected entries in the key event log. Upon successful validation, Node B uses its Block Creator (212) to aggregate validated transactions into a new block, which is subsequently appended to the blockchain. The validated block is then broadcast to the network, ensuring all nodes maintain a consistent and up-to-date copy of the ledger.

The Blockchain Ledger (214) is a distributed ledger maintained by all nodes in the network. It comprises a sequential chain of blocks (216a, 216b, 216c), with each block containing a Block Header (218), a Key Event (220), and Block Data (222). The Block Header (218) includes metadata such as the hash of the previous block, a timestamp, and a Merkle root summarizing the transactions within the block. The Key Event (220), which may be included in the Block Header (218), includes pre-rotated and twice-pre-rotated key hashes, public key, and digital signature. The Block Data (222) contains a list of validated transactions (224a, 224b, 224c), each of which has been verified and cryptographically secured.

The flow of data of a transaction from Node A to Node B may include the pre-rotated and twice-pre-rotated key hashes, public key, and digital signature. Node B validating the transaction and broadcasting it to other nodes in the network. Node B then creates a new block using the Block Creator (212) and adds the new block to the Blockchain Ledger (214).

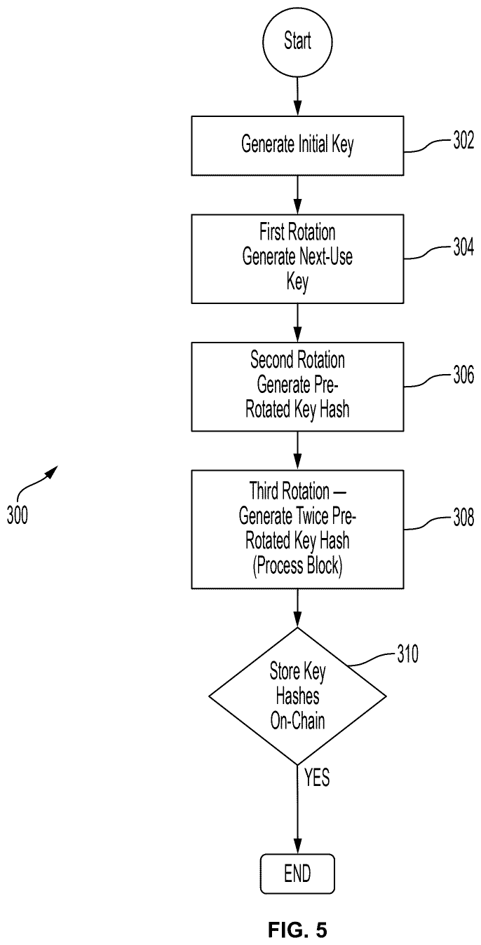

FIG. 5 illustrates the multi-rotation key derivation process (300) for generating cryptographic keys and hashes to secure transactions in the blockchain network. The process begins with Generating an Initial Key (302), which is generated by a participant as the root key in the cryptographic sequence. When a key is first generated, it includes two components—a private key and a chaincode. The combination of the chaincode and the private key enables a participant to derive subsequent child keys, a process referred to as ‘rotation.’ The Initial Key undergoes a series of sequential rotations to derive new cryptographic values that ensure forward security and cryptographic continuity. The Initial Private Key is created using a secure cryptographic key generation technique, such as elliptic curve-based key generation or a secure random number generator. This key forms the foundation of the multi-rotation process and is securely stored by the participant initiating the transaction. The validator node processes these components to verify the transaction's authenticity and adherence to the cryptographic rules defined by the system.

The process continues to the First Rotation (304), which generates Next-Use Key. This key serves as the cryptographic basis for signing the transaction and is a direct transformation of the Initial Key (302) through a pre-defined cryptographic operation. The Next-Use Key is securely stored temporarily and used to generate additional cryptographic outputs required for transaction validation. This transformation is performed using a deterministic cryptographic function, such as a one-way hash function, an elliptic curve transformation, or SHA-256, ensuring that the resulting key is unique and cryptographically linked to the Initial Private Key. The Next Private Key is used to digitally sign the transaction, providing proof of authorization and authenticity.

The second step is the Second Rotation (306), which generates a Pre-Rotated Key Hash, which is derived by applying a first rotation to the Next-Use Key, followed by a cryptographic hash. The Pre-Rotated Key Hash is embedded into the transaction payload and serves as a verifiable reference for validating the transaction during the consensus process.

The third step is the Third Rotation (308), which generates the Twice-Pre-Rotated Key Hash, which is derived by applying a second rotation to the Next-Use Key, followed by a cryptographic hash. The Twice-Pre-Rotated Key Hash is embedded into the transaction payload and serves as a verifiable reference for validating the transaction during the consensus process.

The next step is Storing Key Hashes On Chain (310) The outputs of each step—namely, the Pre-Rotated Key Hash and the Twice-Pre-Rotated Key Hash—are cryptographically linked, transmitted as part of the transaction payload, and stored on-chain for future validation. This process ensures that all future keys are cryptographically dependent on the previous keys in the sequence maintaining a continuous and tamper-proof record of the cryptographic key sequence.

The key event log is maintained on the blockchain ledger as an ordered sequence of key events, each associated with a specific transaction. These key events form a cryptographically linked chain that enables validators to verify the authenticity and continuity of submitted transactions.

Each key event in the key event log contains several fields. The Pre-Rotated Key Hash stores the cryptographic hash of the key derived from the first rotation in the multi-rotation key derivation process. This hash acts as a reference for validating the current transaction and links it to the on-chain cryptographic sequence. The Twice-Pre-Rotated Key Hash contains the cryptographic hash derived from the second rotation, which serves as a forward reference for validating future transactions in the sequence. Additionally, the Public Key of the sender is included in each key event to enable validators to verify the digital signature associated with the transaction. Finally, the Transaction ID, in embodiments, provides a unique identifier that ties the key event to a specific transaction, ensuring both traceability and auditability within the blockchain system.

The cryptographic linkage between successive key events in the key event log is maintained. For example, the Twice-Pre-Rotated Key Hash of a first key event matches the Pre-Rotated Key Hash of a second key event. This linkage ensures cryptographic continuity. In other words, the pre-rotated key hash and twice-pre-rotated key hash serve as forward cryptographic commitments recorded on-chain in the transaction, which allows validators to verify cryptographic continuity in subsequent transactions by matching expected hashes from prior key event log entries.

The on-chain key event log is a part of the blockchain ledger, accessible to all participating nodes. Validator nodes utilize the key event log during transaction validation to confirm that the submitted Pre-Rotated Key Hash and Twice-Pre-Rotated Key Hash align with the corresponding entries in the log. This verification ensures that each transaction complies with the cryptographic rules established by the disclosed system. Transactions generated by participant nodes include the Pre-Rotated Key Hash and are validated against the key event log before being appended to the blockchain. Transactions that fail validation, due to mismatched key event log records, are rejected and excluded from the ledger, safeguarding the blockchain's integrity.

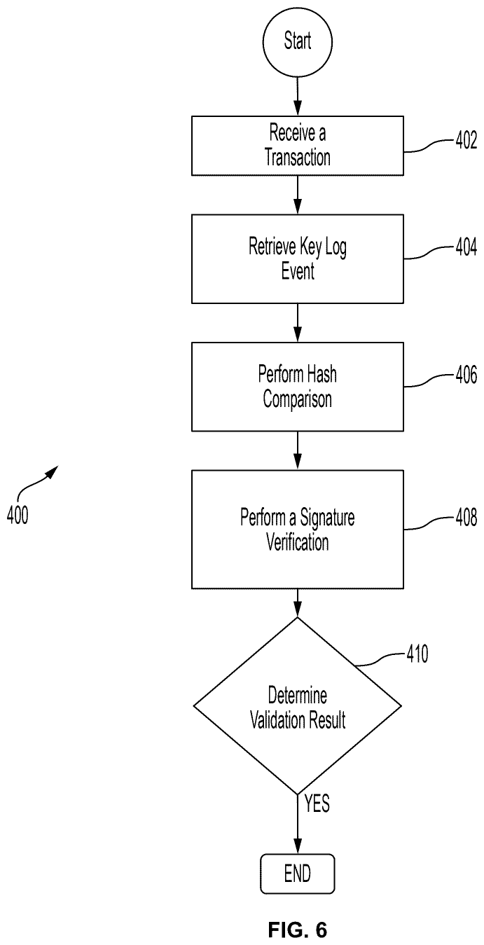

In some embodiments, multi-rotation key derivation incorporates a multifactor derivation algorithm providing enhanced security through indexed levels and fixed-depth derivations resistant to brute-force attacks. For example, FIG. 6 illustrates a multifactor derivation algorithm or transaction validation process (400) performed by validator nodes within a blockchain network. The process begins with a Transaction Receipt (402), where a validator node receives a submitted transaction from a participant node. The received transaction includes several components: a Pre-Rotated Key Hash generated by the sender using a private key, a Twice-Pre-Rotated Key Hash generated by the sender using the same private key, the Public Key of the sender, the transaction inputs and outputs, and the sender's Digital Signature.

The next step is Key Event Log Retrieval (404), where the validator node retrieves the on-chain key event log from the blockchain ledger. The key event log contains cryptographically linked records corresponding to past transactions, including Pre-Rotated Key Hashes, Twice-Pre-Rotated Key Hashes, Public Keys, and Transaction IDs. This data is used to confirm that the submitted transaction aligns with the cryptographic sequence recorded on-chain.

In the Hash Comparison (406) step, the validator compares the submitted Pre-Rotated Key Hash to the corresponding entry in the key event log. The validator compares the submitted Pre-Rotated Key Hash with the corresponding value in the key event log, confirming that the transaction adheres to the expected cryptographic sequence. The validator ensures that the Twice-Pre-Rotated Key Hash from the previous transaction matches the Pre-Rotated Key Hash of the current transaction. This step verifies continuity between successive transactions, preventing tampering. The validator checks the submitted Digital Signature using the Public Key to confirm that the transaction is authorized by the legitimate key owner and that the data remains untampered during transmission.

Once the hash comparison is complete, in some embodiments, the validator performs Signature Verification (408). In this step, the validator uses the sender's Public Key, retrieved from the key event log, to verify the Digital Signature included in the transaction. The verification ensures that the transaction was authorized by the owner of the private key associated with the Public Key and that no unauthorized modifications have been made to the transaction data.

In embodiments, validation of a transaction or key event is accepted or rejected based on specific rules. A first rule, in embodiments, is that if a key event is created and no corresponding on-chain key event exists, it is considered an inception event. This event must be committed individually to the blockchain. This transaction must not send coins to addresses outside those listed in the public key hashes of the key event log. In one example, sending coins outside the public key hashes in the key event log would be identified by a transaction output address which does not equal the Pre-Rotated Key Hash value in the same transaction/key event. This transaction must not attempt an identity action. In this example, an identity action is identified by a non-blank value specified in the relationship field of the transaction. The blockchain should reject any further key events/transactions until this inception key event/transaction is included in a block on the blockchain.

A second rule, in embodiments, is that if the transaction sends coins outside of the public key hashes in the Key Event Log, it requires a confirming key event, i.e. one of the transaction outputs does not equal the Pre-Rotated Key Hash of the transaction or the Twice Pre-Rotated Key Hash of the previous on-chain transaction/key-event. A third rule, in embodiments, is that if the transaction attempts an identity action, it requires a confirming key event, i.e., populates the relationship field in the message column.

A fourth rule, in embodiments, is that if a transaction only rotates the key and/or consolidate outputs, no confirming key event will be required. A key event is considered a confirming key event if the following conditions are met: 1) the transaction does not send coins outside of the public key hashes in the key event log; 2) the transaction does not populate the relation field, meaning it must not attempt an identity action; and 3) is not an inception key event.

Validation, in embodiments, is performed utilizing the following formulas for matching two records:

$$H ( {P}_{p u b} ( i ) ) = {K}_{prerotated} ( i - 1 )$$

$${K}_{twiceprerotated} ( i ) = {K}_{prerotated} ( i + 1 )$$

Validation, in embodiments, is performed utilizing the following formulas for non-conditional transactions:

$${K}_{outputs} = {K}_{prerotated}$$

These checks, in embodiments are performed by consensus nodes during transaction validation.

Digital signature validation, in embodiments, utilizes the following formulas:

$${H}_{tx} = SHA 256 ( data )$$

Where:
Hₜₓ, Transaction hash.
data, Transaction data (e.g., public key, outputs, metadata).

$$σ = {Sign}_{p r i v} ( {H}_{tx} )$$

$$V = {Verify}_{p u b} ( σ , {H}_{tx} )$$

Where:
σ, Digital signature.
Hₜₓ, Transaction hash.
V, Validation result.

The final step is the Validation Result (410). If the transaction passes the hash comparison and signature verification, it is deemed valid and added to the pending block for inclusion in the blockchain. If any of the validation steps fail—such as a mismatch in the key hashes, an invalid digital signature, or tampered transaction data—the transaction is rejected and excluded from the blockchain ledger.

The disclosed multi-rotation key derivation and on-chain validation methods and systems system integrates seamlessly with existing blockchain consensus mechanisms, including Proof of Work (PoW), Proof of Stake (PoS), and other models. By leveraging the inherent cryptographic principles of these mechanisms, the system enhances transaction security without requiring significant modifications to the underlying blockchain infrastructure. This process involves integrating the cryptographic validation system into various consensus models. For PoW, validator nodes (miners) embed the cryptographic checks for Pre-Rotated and Twice-Pre-Rotated Key Hashes into the transaction validation process before including transactions in candidate blocks. Once a miner solves the computational puzzle, the validated block is appended to the blockchain. In PoS, validators retrieve and verify cryptographic data from the key event log and include valid transactions in a proposed block. Due to its low computational overhead, the system ensures scalability in PoS without disrupting the consensus process.

Additionally, the system is compatible with alternative consensus models such as Delegated Proof of Stake (DPoS) and Practical Byzantine Fault Tolerance (PBFT). For example, in DPoS, selected delegates perform the validation steps described above, ensuring cryptographic security without excessive resource demands. In PBFT, cryptographic checks are incorporated into the consensus rounds, ensuring all nodes agree on valid transactions before finalizing a block.

Once consensus is achieved, the validated block is appended to the blockchain ledger, ensuring all network participants maintain an updated, synchronized copy. Validator nodes then distribute the new block to all participants, further enhancing the consistency and reliability of the distributed ledger.

Below illustrates an embodiment of a multifactor key derivation algorithm that enhances security through unique indexed levels, fixed-depth derivation, and hardened cryptographic transformations.

```
const deriveIndex = async (factor, level) => {
  const hash = await generateSHA256(factor + level);
  return parseInt(hash.toString(“hex”), 16) % 2147483647; // Modulo 2\hat{ }31
};
// Generate a secure derivation path
export const deriveSecurePath = async (root, secondFactor) => {
  let currentNode = root;
  // Fixed 4-level path
  for (let level = 0; level < 4; level++) {
    const index = await deriveIndex(secondFactor, level);
    currentNode = currentNode.deriveHardened(index);
  }
  return currentNode;
};
```

As shown above, the process begins with a deriveSecurePath function that computes a unique index for each level by hashing the second factor (e.g., user identifier) together with the level number. This ensures that even if the second factor remains the same across derivations, the resulting indices at each level will always be unique. The algorithm enforces a fixed depth, specified as a parameter (e.g., 4 levels), allowing for structured key hierarchies while maintaining security constraints. Furthermore, the derivation process employs hardened derivation via deriveHardened, which prevents public keys from being used to reverse-engineer private keys, adding an additional layer of security.

As an example output, a mnemonic phrase combined with a second factor of user_id123 produces a sequence of uniquely derived indices: Level 0 Index: 123456789; Level 1 Index: 987654321; Level 2 Index: 543212345; and Level 3 Index: 678901234. These values result in a cryptographic path formatted as: m/123456789′/987654321′/543212345′/678901234′

A use case using a typical CPU core can compute approximately 10⁶-10⁷ HMAC-SHA512 operations per second. Assuming a brute-force attempt with 1 million derivations per second, an attack on 2³¹ keys would require approximately 36 minutes. However, at depth 3 (2⁹³), even with a significantly large number of GPUs operating in parallel, breaking the keyspace remains computationally infeasible.

A second use case using top-tier GPUs that are capable of computing 10⁹ derivations per second. Even if each derivation takes 50 microseconds, a distributed system of 1 million GPUs would still require approximately 79 billion years to brute-force the keyspace. The figure emphasizes that, even with the most powerful computational resources available today, brute-forcing this cryptographic structure is virtually impossible. This analysis confirms that the multifactor key derivation algorithm provides a robust security model against brute-force attacks, reinforcing its suitability for cryptographic key management in blockchain and decentralized security applications.

The disclosed methods and systems have broad applicability across a wide range of domains, including financial transactions, identity systems, supply chain management, smart contracts, and the security of Internet of Things (IoT) devices. One application of the disclosed system is in securing financial transactions on blockchain networks. The multi-rotation key derivation mechanism ensures that each transaction is cryptographically tied to the next, preventing the reuse of compromised keys or unauthorized signatures. For instance, in a peer-to-peer payment system, a user initiating a transfer includes the Pre-Rotated Key Hash and Twice-Pre-Rotated Key Hash in the transaction payload. Validator nodes retrieve these hashes from the on-chain key event log and validate them to confirm the transaction's authenticity. By providing dual-layer cryptographic validation, the system mitigates risks such as double-spending or fraudulent transactions. This makes it particularly valuable for financial institutions and platforms leveraging blockchain, including cryptocurrency exchanges, cross-border payment systems, and decentralized finance (DeFi) applications. The enhanced security offered by this system builds trust and confidence in digital asset transactions.

The disclosed methods and systems also offer significant benefits for decentralized identity (DID) frameworks and self-sovereign identity models by securing user credentials and ensuring the integrity of identity-related transactions. Each user's identity is linked to a unique cryptographic key sequence stored in the on-chain key event log. For example, when a user verifies their identity with a service provider, the Pre-Rotated Key Hash from the key event log is compared against the submitted credentials to confirm authenticity. The Twice-Pre-Rotated Key Hash ensures that validation requests are cryptographically tied to prior activity, preventing unauthorized access or identity spoofing. This transparent and tamper-resistant method of managing identities is suitable for applications such as digital identity wallets, secure voting systems, and access control frameworks, offering a scalable solution for managing identity in decentralized environments.

The methods and systems, in embodiments, enhance decentralized identity standards, such as the Key Event Receipt Infrastructure (KERI), by securely tying decentralized identifiers (DIDs) to the transaction validation process. By integrating DIDs with the secure key rotation mechanism, the system ensures that identifiers are not only securely rotated but also validated against an immutable on-chain log. This process strengthens the integrity of DIDs, creating a robust and tamper-proof framework for identity management. Such a solution is particularly useful for decentralized systems that require high levels of trust, transparency, and cryptographic continuity in managing digital identities.

Use cases of the methods and systems disclosed herein include securing decentralized financial transactions, decentralized identity authentication. Beyond blockchain, the methods and systems may be applied to traditional web authentication systems and secure sessions on the web. Integrating key rotation mechanisms enhances session security and prevents unauthorized access to online accounts or services. Specifically, this approach strengthens the cryptographic protections for user credentials during login and throughout an active session, mitigating risks associated with session hijacking or key compromise.

While the disclosed methods and systems, in embodiments, are designed to operate efficiently and securely within existing blockchain infrastructures, optional enhancements can be incorporated to further strengthen security, improve scalability, and optimize performance for specific use cases. These enhancements leverage advanced technologies and hardware solutions to complement the core multi-rotation key derivation and on-chain validation mechanisms.

Hardware Security Modules (HSMs) and secure wallets can be integrated into the system to enhance key management and protect cryptographic operations. HSMs are specialized hardware devices designed to securely generate, store, and manage cryptographic keys. By utilizing HSMs, the private keys used in the multi-rotation key derivation process can be securely stored, ensuring that they remain inaccessible to unauthorized users. For instance, the Initial Private Key and subsequent derived keys can be generated and stored within an HSM, reducing the risk of key exposure during cryptographic operations.

Similarly, secure wallets, such as hardware wallets, can provide an additional layer of security for end-users by isolating key storage and transaction signing processes from potentially vulnerable environments (e.g., personal computers or mobile devices). These wallets can integrate directly with the blockchain system, ensuring that all key management and signing operations occur within a secure environment. The combination of HSMs and secure wallets provides a robust solution for enterprises and individuals looking to enhance the security of their blockchain transactions.

To further optimize performance and scalability, the system can integrate advanced computing technologies, including edge computing and quantum computing. Deploying edge computing for transaction validation can occur closer to the data source, such as at dedicated validator nodes located at network edges. For example, the Pre-Rotated Key Hash and Twice-Pre-Rotated Key Hash validation steps can be executed at edge nodes, reducing processing time and improving responsiveness for applications like financial trading or real-time identity verification.

In embodiments, the methods and systems could also serve as a robust validation layer for cross-chain bridges, ensuring that transactions moving between blockchains are secure and adhere to established cryptographic rules. By applying the multi-rotation key derivation mechanism and on-chain validation process, the invention guarantees that cross-chain transactions are cryptographically verified, preventing unauthorized transfers and maintaining the integrity of assets as they transition between different blockchain networks.

Other applications include enhancing governance models, Layer 2 scaling solutions, and compatibility with evolving standards. Layer 2 solutions are scalability frameworks or protocols that operate on top of a blockchain's base layer (Layer 1, such as Ethereum or Bitcoin) to improve the network's performance, typically by increasing transaction throughput and reducing fees. Through secure key rotation, it ensures the integrity of governance models where voting or decision-making relies on blockchain-based credentials, providing tamper-proof authentication and validation. Additionally, it can serve as a security layer for Layer 2 scaling solutions by ensuring that off-chain transactions comply with on-chain validation rules when settled back on the main chain. Furthermore, the system is designed for adaptability, allowing integration with evolving blockchain standards, such as post-quantum cryptography, to future-proof networks against emerging threats and maintain long-term security.

As blockchain networks evolve, the threat of quantum computing breaking traditional cryptographic algorithms becomes a concern. The disclosed system can incorporate quantum-resistant algorithms to ensure security against quantum attacks. Additionally, quantum computing can be leveraged for its processing power to optimize the multi-rotation key derivation process, enabling faster computation of cryptographic hashes and key sequences. This capability can significantly enhance the scalability of the system for use in high-volume blockchain networks.

The methods and systems disclosed herein may be utilized using a distributed deployment architecture of the disclosed multi-rotation key derivation and on-chain validation system, showcasing its modular and decentralized design. The architecture is comprised of multiple nodes performing distinct roles, including Participant Nodes, Validator Nodes, Consensus Nodes, and the Distributed Key Event Log Storage. These components collaboratively maintain the integrity, scalability, and fault tolerance of the blockchain network.

At the user level, Participant Nodes are responsible for generating transactions. Each participant node is equipped with a Key Derivation Module, which performs the multi-rotation process to generate cryptographic outputs such as the Pre-Rotated Key Hash and Twice-Pre-Rotated Key Hash. These hashes are embedded into the transaction payload along with the participant's Digital Signature, ensuring cryptographic integrity. Once generated, the transaction is propagated to the blockchain network for validation.

The Validator Nodes receive transactions from participant nodes and perform the necessary validation steps. Each validator node retrieves the relevant records from the On-Chain Key Event Log, which is a distributed ledger maintained across the blockchain network. The validator verifies the cryptographic linkage between the submitted Pre-Rotated Key Hash and the corresponding entry in the key event log, ensuring that the transaction aligns with the cryptographic sequence. Additionally, the validator confirms that the Twice-Pre-Rotated Key Hash from the previous transaction matches the Pre-Rotated Key Hash of the current transaction, maintaining cryptographic continuity. The validator also verifies the transaction's Digital Signature using the sender's public key. Transactions that pass all validation steps are added to a candidate block, which is submitted for consensus.

Put differently, these on-chain validation rules ensure the integrity of transactions. Each transaction is validated against the pre-rotated key hashes logged on the blockchain, providing a cryptographically secure reference point. Validator nodes verify whether the public key associated with a transaction matches both the expected pre-rotated and twice-pre-rotated key hashes recorded on-chain. This dual-layer verification process ensures that every transaction adheres to the cryptographic sequence established by the key rotation mechanism. Any deviation from this sequence—such as the unauthorized use of a compromised or invalid key—results in the immediate rejection of the transaction during the consensus process, thereby maintaining the security and integrity of the blockchain ledger.

The Consensus Nodes are responsible for agreeing on the inclusion of validated transactions in new blocks. These nodes operate based on the blockchain's consensus mechanism, such as Proof of Work (PoW) or Proof of Stake (PoS). The consensus nodes finalize new blocks containing validated transactions and broadcast them to the network, ensuring that all nodes maintain a synchronized and up-to-date copy of the blockchain ledger.

The Distributed Key Event Log Storage is a decentralized repository maintained by all nodes in the network. Each node stores a complete copy of the on-chain key event log, ensuring redundancy and fault tolerance. The key event log contains cryptographic records, including the Pre-Rotated and Twice-Pre-Rotated Key Hashes for every transaction. This decentralized storage model ensures that all validator nodes have access to the data required for transaction validation, even in the event of node failures or network disruptions.

If an unauthorized user obtains a private key, the disclosed mechanism ensures that they cannot generate valid future keys without correctly deriving them from the cryptographically secure on-chain log. In embodiments, the methods and systems incorporate a Key Derivation Parameter (KDP), such as a PIN or password, to add an additional layer of cryptographic security. Even in the event of a private key being compromised, an unauthorized user must also correctly obtain the KDP to derive valid future keys—a task that is computationally infeasible. This ensures that only keys validly derived within the sequence are capable of signing transactions, with this validity rigorously enforced at the consensus level. The system operates as both a preventative measure, stopping unauthorized transactions at their root, and a detective mechanism, identifying fraudulent attempts before they can impact the blockchain ledger.

Numbered paragraphs that provide further examples of the methods of the present disclosure are provided below.
A0. A multi-rotation key derivation method for securing transaction in a blockchain network, comprising:
generating, via a processor, an initial key;
generating, via the processor, a next-use key from the initial key;
generating, via the processor, a pre-rotated key hash from the next-use key;
generating, via the processor, a twice-pre-rotated key hash from the next-use key; and
storing, via the processor, the pre-rotated key hash and the twice-pre-rotated key hash on a blockchain ledger.
A1. The method of paragraph A0, wherein the initial key is generated via at least one of an elliptic curve-based key generation or a random number generator.
A2. The method of any of paragraphs A0-A1, wherein the next-use key is generated via transformation of the initial key through at least one of a deterministic cryptographic function or SHA-256.
A3. The method of any of paragraphs A0-A2, wherein the pre-rotated key hash is generated by:
applying, via the processor, a first rotation to the next-use key; and
applying, via the processor, a cryptographic hash.
A4. The method of any of paragraphs A0-A3, wherein the twice-pre-rotated key hash is generated by:
applying, via the processor, a second rotation to the next-use key; and
applying, via the processor, a cryptographic hash.
B0. A transaction validation method, comprising:
receiving, via a processor, a submitted transaction having a pre-rotated key hash and a digital signature;
retrieving, via the processor, an on-chain key event log from a blockchain ledger, the key event log having a plurality of pre-rotated key hashes;
comparing, via the processor, the pre-rotated key hash of the submitted transaction to a corresponding pre-rotated key hash of the plurality of pre-rotated key hashes in the on-chain key event log; and
verifying, via the processor, the digital signature of the submitted transaction based on the comparison of the pre-rotated key hash of the submitted transaction to the corresponding pre-rotated key hash in the on-chain key event log.
B1. The method of paragraph B0, wherein comparing the pre-rotated key hash of the submitted transaction to the corresponding entry in the on-chain key event log includes verifying, via the processor, that a twice-pre-rotated key hash from a previous transaction in the on-chain key event log, matches a pre-rotated key hash of the submitted transaction.
B2. The method of any of paragraphs B0-B1, wherein the processor is associated with a validator node and the submitted transaction is associated with a participant node that is separate and independent from the validator node.

The disclosed methods and systems may be implemented as software, hardware, or a combination of both, depending on the specific deployment scenario and use case. This flexibility allows the system to adapt to various blockchain infrastructures and ensures scalability, security, and efficiency. The methods and systems can be embodied as a set of software modules executed on participant nodes, validator nodes, and/or consensus nodes. Components such as the Key Derivation Module, Transaction Validation Module, and On-Chain Key Event Log Manager are implemented as program code written in programming languages commonly used for blockchain systems, such as Python, C++, Rust, or Go. Each module is designed to perform specific functions, including key generation, cryptographic hash validation, and transaction signing.

The methods and systems are built upon widely accepted cryptographic standards, such as SHA-256 and BIP32 hierarchical deterministic (HD) wallets, ensuring compatibility with established blockchain ecosystems. For example, the Key Derivation Module consists of algorithms to perform the multi-rotation process. They generate the Pre-Rotated Key Hash and Twice-Pre-Rotated Key Hash using cryptographic functions (e.g., SHA-256) and ensure that the resulting hashes are securely embedded into the transaction payload. Similarly, the Transaction Validation Module is responsible for retrieving the on-chain key event log, comparing submitted hashes, verifying digital signatures, and ensuring the cryptographic continuity of transactions.

The program code can be deployed in a variety of execution environments, including on-premises servers, cloud platforms, and edge devices. For instance, validator nodes can execute the validation logic in a distributed cloud environment to improve performance and scalability. The modularity of the software ensures that components can be updated independently without disrupting the entire system.

In embodiments requiring enhanced security, the methods and systems can be partially or fully implemented in hardware. Components such as the Key Derivation Module and Transaction Signing Module can be integrated into Hardware Security Modules (HSMs) or secure hardware wallets. These hardware devices perform cryptographic operations in a tamper-resistant environment, protecting private keys and sensitive data from unauthorized access.

For large-scale deployments, the system may leverage specialized hardware accelerators, such as AI accelerators or quantum processors, to optimize the computational aspects of key derivation and cryptographic validation. These hardware components significantly enhance the performance of the system by reducing the time required for hash computations and transaction validation.

A hybrid implementation combines the flexibility of software with the security of hardware. For example, the Key Derivation Module may run as software on participant nodes, while the private keys and cryptographic operations are securely handled by an HSM or hardware wallet. Validator nodes can execute the transaction validation logic as software but offload intensive cryptographic computations to hardware accelerators for improved efficiency.

In embodiments, the methods and systems may integrate quantum communication channels to secure data transmission between nodes in the blockchain network. Quantum communication, which leverages quantum entanglement and quantum key distribution (QKD), provides a fundamentally secure method for transmitting sensitive information. The system can ensure that cryptographic keys used in the multi-rotation key derivation process are exchanged securely between nodes. Any attempt to intercept or tamper with the key exchange would be immediately detectable due to the properties of quantum mechanics.

For example, in embodiments, validator nodes could establish quantum-secured communication links with consensus nodes to transmit transaction validation results and cryptographic keys. Similarly, participant nodes could use quantum communication to securely submit transaction payloads to validator nodes. This integration would protect against future threats posed by quantum computers, which could potentially break traditional cryptographic algorithms. The adoption of quantum-secured communication would position the system at the forefront of blockchain security, providing resilience against emerging technological risks.

Another use of the invention involves the integration of federated learning to enhance transaction security using AI-driven techniques. Federated learning is a decentralized machine learning approach where individual nodes collaboratively train AI models on locally stored data without sharing the data itself. This approach aligns with the decentralized nature of blockchain networks and preserves user privacy.

Federated learning, in embodiments, could be used to develop AI models that identify and predict potential security threats, such as anomalous transaction patterns or malicious activity. For example, each node in the blockchain network could train a local AI model using transaction data and validation results, contributing to a global model that improves the system's ability to detect fraud or other irregularities. These AI-driven insights could then be used to enhance transaction validation rules, ensuring that the system remains adaptive and resilient in the face of evolving security challenges.

The methods and systems disclosed herein provide significant improvement to processing and network functioning by ensuring that only cryptographically validated transactions are processed, thereby enhancing data integrity across the network and reducing the risk of corrupted or fraudulent data entering the blockchain. The validation rules for pre-rotated key hashes are computationally efficient, minimizing overhead on nodes and maintaining high throughput during transaction validation. By automating key rotation and validation, the system eliminates the need for manual or redundant processes, saving both bandwidth and computation time by leveraging on-chain logs for cryptographic continuity. The lightweight nature of the key event log and validation processes supports high transaction volumes without creating bottlenecks, enabling better throughput and scalability. Furthermore, the multi-rotation key derivation and validation mechanisms are designed to provide stronger security with negligible impact on network performance, incorporating enhanced cryptographic protection without adding significant latency or bandwidth consumption. Finally, redundant key event logs stored across all nodes ensure reliability and fault tolerance, preventing data loss and maintaining consistent operation even in the event of node failures.

It will be appreciated that the invention is not restricted to the particular embodiment that has been described, and that variations may be made therein without departing from the scope of the invention as defined in the appended claims, as interpreted in accordance with principles of prevailing law, including the doctrine of equivalents or any other principle that enlarges the enforceable scope of a claim beyond its literal scope. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated. The word “comprise” or a derivative thereof, when used in a claim, is used in a nonexclusive sense that is not intended to exclude the presence of other elements or steps in a claimed structure or method.

What is claimed is:

1. A method for securing transactions in a blockchain network using multi-rotation key derivation, comprising:
deriving, via at least one processor, a first future private key from a current private key using a deterministic cryptographic function;
deriving, via the at least one processor, a second future private key from the first future private key using the deterministic cryptographic function;
deriving, via the at least one processor, a first future public key from the first future private key;
deriving, via the at least one processor, a pre-rotated key hash by applying a cryptographic hash function to the first future public key;
deriving, via the at least one processor, a second future public key from the second future private key;
deriving, via the at least one processor, a twice-pre-rotated key hash by applying the cryptographic hash function to the second future public key;
generating, via the at least one processor, a transaction payload having a current public key corresponding to the current private key, the pre-rotated key hash, and the twice-pre-rotated key hash;
generating, via the at least one processor, a digital signature by signing the transaction payload with the current private key; and
submitting, via the at least one processor, the transaction including the transaction payload and the digital signature to the blockchain network.

2. The method of claim 1, wherein the deterministic cryptographic function includes an elliptic curve cryptographic operation.

3. The method of claim 1, wherein the cryptographic hash function includes at least one of SHA-256 or RIPEMD160.

4. The method of claim 1, wherein at least one transaction output address in the transaction payload is derived from the current public key.

5. The method of claim 1, wherein deriving the first future private key, the second future private key, the pre-rotated key hash, and the twice-pre-rotated key hash incorporates a multifactor derivation algorithm.

6. The method of claim 1, further comprising storing the pre-rotated key hash and the twice-pre-rotated key hash in the on-chain key event log upon validation of the submitted transaction.

7. A non-transitory computer-readable medium storing instructions that, when executed by at least one processor in a blockchain node, cause the blockchain node to perform the method of claim 1.

8. A method for validating transactions in a blockchain network, comprising:
receiving, via at least one processor, a submitted transaction having a current public key, a submitted pre-rotated key hash, a submitted twice-pre-rotated key hash, and a digital signature;
retrieving, via the at least one processor, a prior key event log entry from an on-chain key event log stored on a blockchain ledger, the prior key event log entry having a prior pre-rotated key hash and a prior twice-pre-rotated key hash;
verifying, via the at least one processor, a cryptographic continuity by:
confirming that a hash of the current public key matches the prior pre-rotated key hash, and
confirming that the submitted pre-rotated key hash matches the prior twice-pre-rotated key hash;
verifying, via the at least one processor, the digital signature using the current public key; and
upon successful verification of the cryptographic continuity and the digital signature, accepting the submitted transaction and updating the on-chain key event log with the submitted pre-rotated key hash and the submitted twice-pre-rotated key hash.

9. The method of claim 8, wherein one or more steps of verifying the cryptographic continuity is performed via a cryptographic hash function that includes at least one of SHA-256 or RIPEMD160.

10. The method of claim 8, wherein the method is performed during a consensus process of the blockchain network.

11. The method of claim 8, wherein the method is performed by a validator node separate from a participant node that provided the submitted transaction.

12. The method of claim 8, wherein the pre-rotated key hash and the twice-pre-rotated key hash serve as forward cryptographic commitments for subsequent transaction validations.

13. A non-transitory computer-readable medium storing instructions that, when executed by at least one processor in a blockchain node, cause the blockchain node to perform the method of claim 8.

14. A blockchain system for fraud-resistant transaction validation, comprising:
a plurality of nodes communicatively coupled via a network, each node including at least one processor and memory storing a plurality of instructions that, when executed, cause the at least one processor to:
perform multi-rotation key derivation by: (1) deriving a first future private key from a current private key, (2) deriving a second future private key from the first future private key, (3) deriving a first future public key from the first future private key, (4) deriving a pre-rotated key hash from the first future public key by applying a cryptographic hash function, (5) deriving a second future public key from the second future private key, and (6) deriving a twice-pre-rotated key hash from the second future public key by applying the cryptographic hash function;
prepare a transaction having (a) a current public key corresponding to the current private key, the pre-rotated key hash, and the twice-pre-rotated key hash in a transaction payload, and (b) a digital signature generated using the current private key;
validate received transactions by: (i) retrieving a prior key event log entry from an on-chain key event log, (ii) confirming a cryptographic continuity through matching of a hash of a submitted current public key to a prior pre-rotated key hash and a submitted pre-rotated key hash to a prior twice-pre-rotated key hash, and (iii) verifying the digital signature; and
upon validation, append the transaction to a blockchain ledger and update the on-chain key event log with the submitted pre-rotated key hash and twice-pre-rotated key hash.

15. The system of claim 14, wherein the on-chain key event log comprises an ordered sequence of entries, wherein each entry of the ordered sequence of entries includes at least a public key, a pre-rotated key hash, a twice-pre-rotated key hash, and a transaction identifier.

16. The system of claim 14, wherein the plurality of nodes includes participant nodes configured to prepare and submit transactions and validator nodes configured to perform validation.

17. The system of claim 14, wherein multi-rotation key derivation incorporates a multifactor derivation algorithm.

18. The system of claim 14, wherein the cryptographic hash function comprises at least one of SHA-256 or RIPEMD160.
